(19) United States
(12) Patent Application Publication
(10) Pub. No.: US 2006/0271330 A1
(43) Pub. Date: Nov. 30, 2006

(54) Automatic transmission apparatus

(75) Inventors: Zhi-An Yin, Shenzhen (CN); Jun-Hua Yang, Shenzhen (CN); Yan-Kai Zhang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/443,116

(22) Filed: May 30, 2006

(30) Foreign Application Priority Data
May 27, 2005 (TW) 94117386

(51) Int. Cl. G06F 15/00

(52) U.S. Cl. 702/127

(57) ABSTRACT

An automatic transmission apparatus (200) includes a transmission floor (210), at least one board (220), a first stopping unit (230), a second stopping unit (240), a plurality of inspecting units (250, 251, 252), and a controlling unit (260). The transmission floor has a plurality of rollers positioned at two long sides thereof. The at least one board is positioned on the rollers. The first and seccond stopping units are positioned along a path of movement of the at least one board along the transmission floor. The second stopping unit is along a predetermined distance from the first stopping unit. The inspecting units generate a plurality of inspecting signals according to a current position of the board. The controlling unit receives the inspecting signals and controls the first and second stopping units according to the inspecting signals. The first and second stopping units stop the at least one board from moving.

### TECHNICAL FIELD

The present invention relates a transmission apparatus used in applications such as an LCD (liquid crystal display) testing line.

### BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions.

In order to ensure the quality of newly manufactured LCDs, a series of tests for checking the functions of the LCDs must be performed before the LCDs leave the factory. Generally, a transmission apparatus for transmitting LCDs between different testing devices is used in the testing process, in order to improve the testing efficiency.

FIG. 3 is an isometric view of part of a typical transmission apparatus used in an LCD testing line, together with two LCDs positioned thereon. The transmission apparatus 100 includes a transmission floor 110 having a plurality of rollers 111 positioned at two long sides thereof, a plurality of boards 120, 121 positioned on the rollers 111, a first stopping unit 130 positioned on a central long axis of the transmission floor 110, a second stopping unit 140 positioned on the central long axis of the transmission floor 110 a predetermined distance from the first stopping unit 130, a first button 131 used to control the first stopping unit 130, and a second button 141 used to control the second stopping unit 140.

An area of the transmission floor 110 between the first stopping unit 130 and the second stopping unit 140 is defined to be an operating area. The boards 120, 121 can move along the transmission floor 110 at a predetermined speed, and are provided for carrying products (such as LCDs 180) to be tested. After the LCDs 180 on the board 121 arrive at the operating area and stop, a testing device (not shown) performs a test procedure to check one or more of functions of the LCDs 180. For example, the testing device may test a contrast ratio of each of the LCDs 180.

The first and second stopping units 130, 140 can be raised to stop the boards 120, 121. The first and second stopping units 130, 140 can also be lowered under the boards 120, 121, to allow the boards 120, 121 to move along the transmission floor 110. Each of the stopping units 130, 140 is driven by an electric motor (not shown) or compressed air driving device.

When an operator presses the first button 131 or the second button 141, an electrical signal is generated by a circuit board (not shown) and is applied to drive the corresponding motor or compressed air driving device. Then the corresponding first stopping unit 130 or second stopping unit 140 is lowered under the boards 120, 121. Otherwise, in a normal status when neither of the buttons 131, 141 is pressed, the first stopping unit 130 and the second stopping unit 14 are in the raised position and stop the boards 120, 121 from moving.

However, the movement of the boards 120, 121 is controlled by the operator who presses the first button 131 and the second button 141. Thus, the transmission apparatus is subject to human error. For example, if the operator presses the first button 131 when the board 121 is still in the operating area, the board 120 moves toward the operating area and may collide with the board 121. When this happens, one or more of the LCDs 180 on the boards 120, 121 may be damaged.

It is desired to provide an automatic transmission apparatus which overcomes the above-described deficiencies.

### SUMMARY

An automatic transmission apparatus includes a transmission floor, at least one board, a first stopping unit, a second stopping unit, a plurality of inspecting units, and a controlling unit. The transmission floor has a plurality of rollers positioned at two long sides thereof. The at least one board is positioned on corresponding of the rollers and is configured for carrying at least one object to be transmitted. The first stopping unit is positioned along a path of movement of the at least one board along the transmission floor. The second stopping unit is positioned along the path of movement of the at least one board along the transimission floor a predetermined distance from the first stopping unit. The inspecting units generate a corresponding plurality of inspecting signals according to a current position of the at least one board. The controlling unit receives the inspecting signals and controls the first and second stopping units according to the inspecting signals. The first and second stopping units are configured for stopping the at least one board from moving.

Advantages and novel features of the above-described automatic transmission apparatus will become more apparent from the following detailed description when taken in conjunction with the accompanying drawings.

### BRIEF DESCRIPTION OF THE DRAWINGS

FIG. 1 is an isometric view of part of an automatic transmission apparatus according to a preferred embodiment of the present invention, together with two LCDs positioned thereon.

FIG. 2 is a driving circuit diagram of the automatic transmission apparatus shown in FIG. 1.

FIG. 3 is an isometric view of part of a typical transmission apparatus used in an LCD testing line, together with two LCDs positioned thereon.

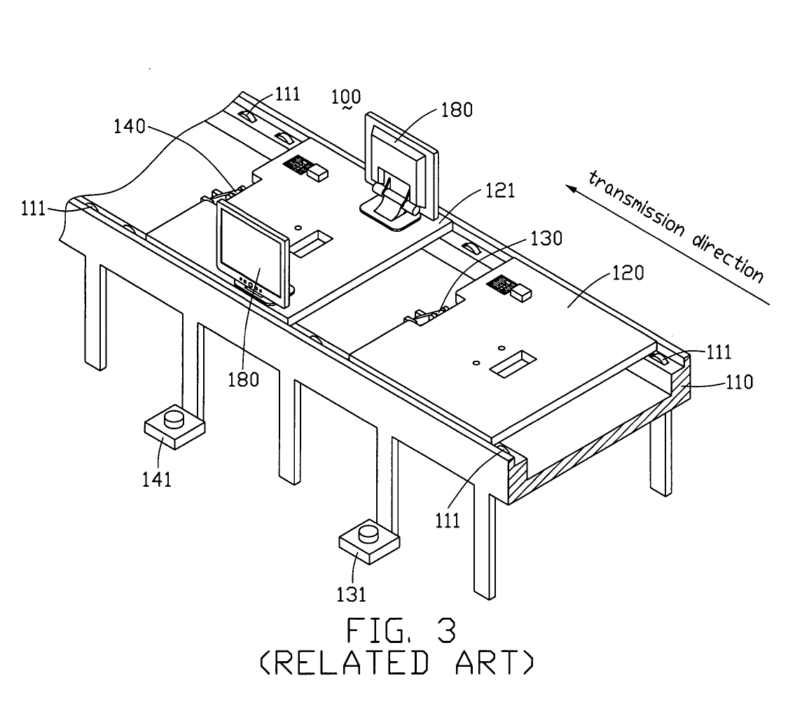

### DETAILED DESCRIPTION OF PREFERRED EMBODIMENTS

Reference will now be made to the drawings to describe the present invention in detail.

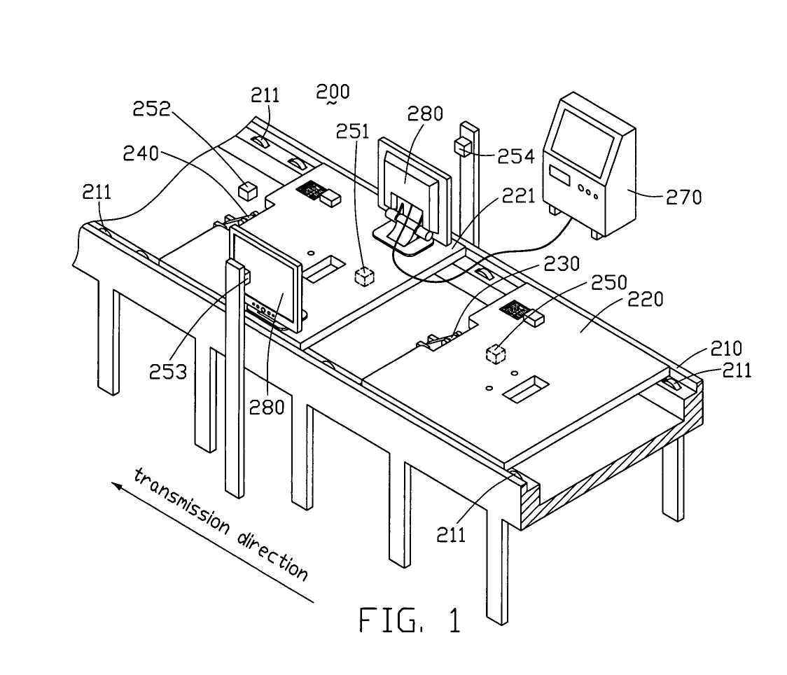

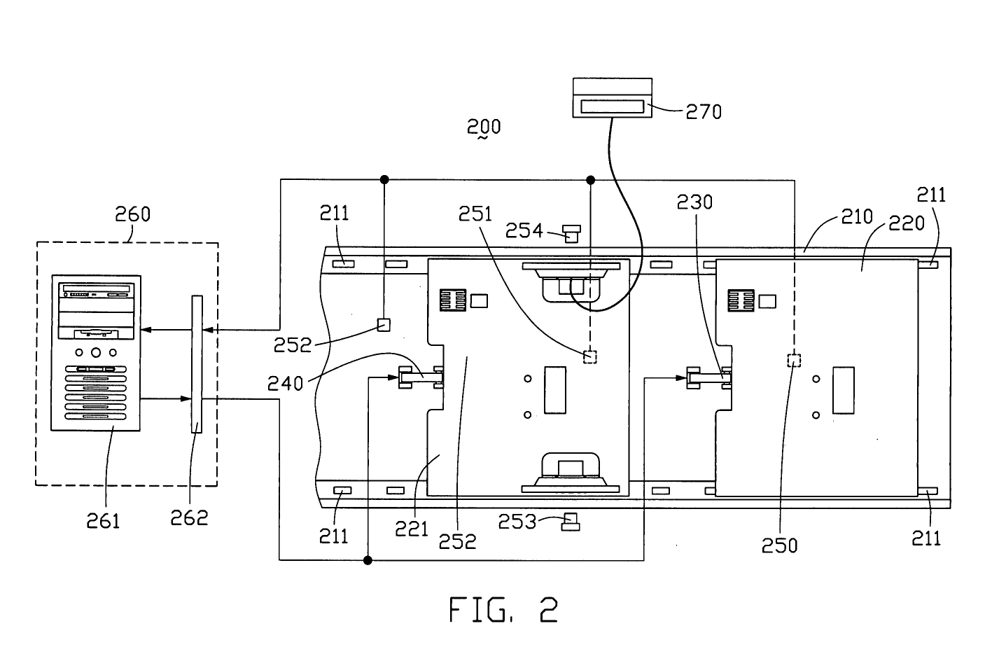

Referring to FIG. 1 and FIG. 2, an automatic transmission apparatus 200 typically used in an LCD testing line according to a preferred embodiment of the present invention includes a transmission floor 210 having a plurality of rollers 211 positioned at two long sides thereof, a plurality of boards 220, 221 positioned on the rollers 211, a first stopping unit 230 positioned on a central long axis of the transmission floor 210, a second stopping unit 240 positioned on the central long axis of the transmission floor 210 a predetermined distance from the first stopping unit 230, a controlling unit 260, and a testing device 270 provided for testing LCDs 280 positioned on the boards 220, 221 and generating corresponding test signals. A direction of transmission of the boards 220, 221 is from the first stopping unit 230 to the second stopping unit 240.

The automatic transmission apparatus 200 further includes a first inspecting unit 250 disposed short of the first stopping unit 230 and being beneath a path of travel of the boards 220, 221, a second inspecting unit 251 disposed between the first stopping unit 230 and the second stopping unit 240 and being beneath the path of travel of the boards 220, 221, a third inspecting unit 252 disposed beyond the second stopping unit 240 and being beneath the path of travel of the boards 220, 221, a fourth inspecting unit 253 disposed between the first stopping unit 230 and the second stopping unit 240 and being above the boards 220, 221 at one of the long sides of the transmission floor 210, and a fifth inspecting unit 254 disposed between the first stopping unit 230 and the second stopping unit 240 and being above the boards 220, 221 at the other long side of the transmission floor 210. That is, the fifth inspecting unit 254 is opposite the fourth inspecting unit 253.

The controlling unit 260 includes a computer 261 and an I/O PCB (input/output printed circuit board) 262.

An area of the transmission floor 210 between the first stopping unit 230 and the second stopping unit 240 is defined as an operating area. The distance between the stopping units 230, 240 is longer than a corresponding length of each board 220, 221. The boards 220, 230 can move along the transmission floor 210 at a predetermined speed, and are provided for carrying the LCDs 280. The first stopping unit 230 and the second stopping unit 240 are used to stop the boards 220, 221 moving along the transmission floor 210. The stopping units 231, 241 can be raised to prevent the boards 220, 221 from moving, and can also be lowered under the boards 220, 221 to allow the boards 220, 221 to move. Each of the stopping units 230, 240 is driven by an electric motor (not shown) or a compressed air driving device (not shown).

The first, second, and third inspecting units 250, 251, 252 positioned under the path of travel of the boards 220, 221 can respectively generate a plurality of inspecting signals according to the positions of the boards 220, 221. The fourth and fifth inspecting units 253, 254 can respectively generate inspecting signals according to whether a corresponding LCD 280 is on the respective board 220 or 221 when the board 220 or 221 is in the operating area. The inspecting units 250, 251, 252, 253, 254 respectively include a optical sensor.

When two LCDs 280 on the board 221 are stationed in the operating area, one or more testing devices perform one or more test procedures to check one or more of functions of the LCDs 280. For example, a single testing device 270 may test a contrast ratio of each of the LCDs 280. The testing device 270 generates one or more corresponding test signals after the testing has been finished.

The computer 261 can receive the inspecting signals and the test signals via the I/O PCB 262, and generate a plurality of controlling signals according to the received signals. Then, the computer 261 applies the controlling signals to the electric motor (not shown) or the compressed air driving device (not shown) via the I/O PCB 262, in order to control the stopping units 230, 240 as needed.

Unlike with the above-described conventional transmission apparatus 100, in the automatic transmission apparatus 200 the movements of the boards 220, 221 are controlled by the controlling unit 260 according to the inspecting signals and test signals received. The automatic transmission apparatus 200 does not need an operator to control the movements of the boards 220, 221. This saves costs and essentially elimates human error. For example, the board 220 cannot be inadvertently moved toward the operating area whereby it collides with the board 221 stationed thereat. Thus the LCDs 280 positioned on the boards 220, 221 are protected from accidental damage.

It is to be understood, however, that even though numerous characteristics and advantages of the preferred embodiments have been set out in the foregoing description, together with details of the structures and functions of the embodiments, the disclosure is illustrative only; and that changes may be made in detail, especially in matters of shape, size, and arrangement of parts within the principles of present invention to the full extent indicated by the broad general meaning of the terms in which the appended claims are expressed.

What is claimed is:

1. An automatic transmission apparatus comprising:
a transmission floor having a plurality of rollers positioned at two long sides thereof;
at least one board positioned on corresponding of the rollers, the at least one board configured for carrying at least one object to be transmitted;
a first stopping unit positioned along a path of movement of the at least one board along the transmission floor, the first stopping unit configured for stopping the at least one board from moving;
a second stopping unit positioned along the path of movement of the at least one board along the transimission floor a predetermined distance from the first stopping unit, the second stopping unit configured for stopping the at least one board from moving;
a plurality of inspecting units configured for generating a corresponding plurality of inspecting signals according to a current position of the at least one board; and
a controlling unit configured for receiving the inspecting signals and controlling the first stopping unit and the second stopping unit according to the inspecting signals.

2. The automatic transmission apparatus as claimed in claim 1, wherein the inspecting units are disposed under the path of movement of the at least one board along the transmission floor.

3. The automatic transmission apparatus as claimed in claim 2, wherein one of the inspecting units is disposed short of the first stopping unit, another one of the inspecting units is disposed between the first and the second stopping units, and a further one of the inspecting units is disposed beyond the second stopping unit.

4. The automatic transmission apparatus as claimed in claim 3, wherein a distance between the first and second stopping units is longer than a corresponding length of the at least one board.

5. The automatic transmission apparatus as claimed in claim 1, wherein the at least one object is a liquid crystal display (LCD).

6. The automatic transmission apparatus as claimed in claim 1, further comprising another inspecting unit disposed above the at least one board at one of the long sides of the transmission floor, wherein said another of the inspecting units is configured for generating an inspecting signal according to whether or not at least one of the at least one object is on the at least one board.

7. The automatic transmission apparatus as claimed in claim 6, wherein the controlling unit is further configured for receiving the inspecting signal from said another of the inspecting units and controlling the first stopping unit and the second stopping unit according to the inspecting signal received from said another of the inspecting units.

8. The automatic transmission apparatus as claimed in claim 7, further comprising a testing device provided for testing the at least one object and generating a corresponding test signal.

9. The automatic transmission apparatus as claimed in claim 8, wherein the controlling unit is further configured for receiving the test signal and controls the first stopping unit and the second stopping unit according to the received test signal.

10. The automatic transmission apparatus as claimed in claim 9, wherein the controlling unit comprises a computer, and the computer generates a controlling signal according to the inspecting signals and the test signal.

11. The automatic transmission apparatus as claimed in claim 10, wherein the controlling unit further comprises an input/output printed circuit board (I/O PCB), and the computer receives the inspecting signals and the test signal via the I/O PCB.

12. The automatic transmission apparatus as claimed in claim 11, further comprising a motor or a compressed air driving device, wherein the computer applies the controlling signal to the motor or the compressed air driving device via the I/O PCB in order to control the first stopping unit and the second stopping unit.

13. The automatic transmission apparatus as claimed in claim 1, wherein each of the inspecting units comprises an optical sensor.

14. A method of tesing LCDs, comprising steps of:
providing transmission floor having a plurality of rollers positioned at two long sides thereof;
providing at least one board positioned on corresponding of the rollers, the at least one board configured for carrying at least one object to be transmitted;
providing a first stopping unit positioned along a path of movement of the at least one board along the transmission floor, the first stopping unit configured for stopping the at least one board from moving;
providing a second stopping unit positioned along the path of movement of the at least one board along the transimission floor a predetermined distance from the first stopping unit, the second stopping unit configured for stopping the at least one board from moving;
providing a plurality of inspecting units configured for generating a corresponding plurality of inspecting signals according to a current position of the at least one board; and
providing a controlling unit configured for receiving the inspecting signals and controlling the first stopping unit and the second stopping unit according to the inspecting signals.
